(19) United States
(12) Patent Application Publication
(10) Pub. No.: US 2012/0323783 A1
(43) Pub. Date: Dec. 20, 2012

(54) Method and System for Customizing Fraud Detection

(76) Inventor: Matt Canetto, Centennial, CO (US)

(21) Appl. No.: 13/159,850

(22) Filed: Jun. 14, 2011

(51) Int. Cl. G06Q 40/00

(52) U.S. Cl. 705/44

(57) ABSTRACT

A user interface is used to customize fraud rules. In the interface, the user sets a customized threshold trigger and a customized limit trigger for a fraud rule set. The fraud rule set is applied to an action. Triggering the threshold trigger by the action causes a threshold trigger report to be generated and allows the action. Triggering the limit trigger by the action denies the action.

### CROSS-REFERENCES TO RELATED APPLICATIONS

This application claims the benefit of U.S. Provisional Application No. 61/335,054, filed on Jun. 15, 2010, the entirety of which is incorporated by reference herein.

### BACKGROUND OF THE INVENTION

Prepaid cards can be subject to fraud in a manner that is different from credit cards. Absent an indication of physical theft, many types of prepaid cards are not subject to fraudulent scrutiny of a typical credit card at a point-of-sale, since prepaid cards operate much like cash. Further, many types of prepaid cards are gifted and carry no identification requirements for use.

Prepaid cards can also be subject to procurement fraud. For example, a fraudster may be an employee of a corporation making purchasing gift cards in bulk. In such cases, fraudulent intent can be difficult to detect, since the fraudster has authorization to purchase the gift cards.

Another type of fraud includes purchasing or reloading gift cards with fraudulently sourced funds, such as stolen credit accounts. In such cases, the fraudster takes advantage of the account before it is cancelled.

Issuers of prepaid cards have difficulties detecting fraudulent procurement since traceability may be entangled. This can be compounded by use of the cards, which can provide little indication of the fraudulent procurement.

### BRIEF SUMMARY OF THE INVENTION

Embodiments of the invention provide issuers with the ability to configure customized fraud rules for prepaid cards. Prepaid card issuers desire enhancements to better detect certain types of fraud and/or better meet their needs that are not being addressed by prior fraud rules. By re-designing the way limits and thresholds can be configured and adding these new limits, thresholds and fraud rules, issuers will be able to stop fraud before it occurs, identify fraud that has occurred and block further fraudulent card activity by adapting and customizing fraud rules to be applicable to particular entities, locations, and related actions. Thus, embodiments of the invention can enable issuers to limit losses, reduce chargeback costs and better comply with various laws and regulations.

Embodiments of the invention provide systems and methods for configuring fraud rules. In one such method, a threshold trigger selection and a limit trigger selection may be received from an interface. The threshold trigger selection and a limit trigger selection originate from user inputs made to the interface for configuring custom fraud rules. A processor can be used to set at least one threshold trigger in response to the threshold trigger selection made at the interface. The processor can be further used to set at least one limit trigger in response to the limit trigger selection made at the interface. The at least one threshold trigger and the at least one limit trigger can then be applied to an action. Triggering the threshold trigger causes a threshold trigger report to be generated and allows the action, and triggering at least the limit trigger denies the action. A machine readable medium can be provided as an article of manufacture, which has instructions for causing one or more processors to perform this method.

A user processor can be configured to generate the interface for configuring custom fraud rules for a specific buyer of prepaid cards. A server processor can be in communication with the user processor and configured to receive inputs from the interface to configure a fraud rule set. The fraud rule set can comprise the threshold trigger and a limit trigger. A fraud processor can be in communication with the server processor. The fraud processor can be configured to apply the fraud rule set to the action.

For some embodiments, a case is created by triggering of the at least one threshold trigger, according to a case creation option made at the interface.

For some embodiments, an account related to the action is blocked from further use by triggering of the at least one threshold trigger, according to a blocking option made at the interface.

For some embodiments, the action is a prepaid card purchase order.

For some embodiments, the action is a management aspect of a prepaid card.

For some embodiments, a case is created by triggering of the at least one limit trigger, according to a case creation option made at the interface.

For some embodiments, an account related to the action is blocked by triggering of the at least one limit trigger, according to a blocking option made at the interface.

For some embodiments, the threshold trigger selection made at the interface comprises changing default settings of the threshold trigger.

Another such system and method uses a processor to generate an interface for customizing a fraud rule set, the fraud rule set being applicable to an action and comprising threshold and limit triggers. The processor is used to process a command from the interface to change at least one of the threshold and limit triggers. The processor is also used to change the at least one of the threshold and limit triggers in response to the command. Triggering the threshold trigger causes a threshold trigger report to be generated and allows the action. Triggering the limit trigger denies the action. A machine readable medium can be provided as an article of manufacture, which has instructions for causing one or more processors to perform this method.

For some embodiments, the threshold and limit triggers comprises a location and a prepaid card order amount.

For some embodiments, the threshold and limit triggers comprises a time period and a prepaid card order amount.

For some embodiments, an account related to the action is blocked from further use by meeting at least one of the threshold and limit triggers.

For some embodiments, a report is always generated upon meeting at least one of the threshold and limit triggers.

For some embodiments, at least one of the threshold and limit triggers comprises a velocity.

For some embodiments, a result of meeting the at least one threshold and limit trigger is overridden for certain velocities exceeding the triggering velocity.

For some embodiments, a case is created upon meeting at least one of the threshold and limit triggers.

For some embodiments, the transaction is always denied upon triggering the limit.

For another such system and method, a user processor is configured to generate a user interface for customizing settings for a fraud rule set, the fraud rule set being applicable to particular entity. A rules processor configured for receiving a first command from the user processor to access the settings for the fraud rule set. In response to the first command, current settings are presented for the fraud rule set on the interface. A second command is then received from the user processor to change at least one of the settings of the fraud rule set. At least one setting of the settings of the fraud rule set is changed in response to the second command. A fraud processor may be in communication with the rules processor and configured to apply the changed fraud rule set to an action of the entity. A machine readable medium can be provided as an article of manufacture, which has instructions for causing a processor to perform the method.

### BRIEF DESCRIPTION OF THE DRAWINGS

FIG. 1 is a high-level schematic diagram of a system for use with embodiments of the invention.

FIG. 2 is a high-level schematic diagram of a system, according to an embodiment of the invention.

FIG. 3 is a high-level schematic diagram of a computer for use with embodiments of the invention.

FIGS. 4A and 4B are operational diagrams for methods, according to embodiments of the invention.

FIGS. 5A and 5B are screen shots of an interface for configuring customized fraud rules according to embodiments of the invention.

FIG. 5C is a screen shot of an interface for resolving a case, according to an embodiment of the invention.

FIG. 5D is a screen shot of a consumer prepaid card ordering website for use with embodiments of the invention.

FIGS. 5E and 5F are screen shots of an interface for ordering bulk quantities of prepaid cards, according to embodiments of the invention.

FIGS. 5G-5I are screen shots of an interface for configuring fraud rule overrides, according to embodiments of the invention.

FIG. 5J is a screen shot of an interface for requesting a customized report, according to an embodiment of the invention.

FIG. 5K is a screen shot of a customized report, according to an embodiment of the invention.

### DETAILED DESCRIPTION OF THE INVENTION

Banks that issue prepaid cards are increasingly requesting enhancements in order to better detect certain types of fraud and/or better meet their compliance needs that are not being addressed by the limits, thresholds and fraud rules available today. By re-designing the way limits and thresholds can be configured and adding these new limits, thresholds and fraud rules, users will be able to stop fraud before it occurs, identify fraud that has occurred, and block further fraudulent card activity. The disclosed limit and threshold system will enable issuers to limit losses, reduce chargeback costs and better comply with various laws and regulations, and in effect reduce loads associated with resolving fraudulent activity on computer servers and related systems.

Prior to discussing the specific embodiments of the invention, a further description of some terms can be provided for a better understanding of embodiments of the invention.

A “payment card” can include any suitable card including a prepaid card, credit card, debit card, or charge card.

An “authorization request message” may be a message that includes an issuer account identifier. The issuer account identifier may be a payment card account identifier associated with a payment card. The authorization request message may request that an issuer of the payment card authorize a transaction. An authorization request message according to an embodiment of the invention may comply with ISO 8583, which is a standard for systems that exchange electronic transactions made by cardholders using payment cards.

A “server computer” can be a powerful computer or a cluster of computers. For example, the server computer can be a large mainframe, a minicomputer cluster, or a group of servers functioning as a unit. In one example, the server computer may be a database server coupled to a Web server.

A “trigger” is the high-level rule that is evaluated when determining whether to apply a limit, threshold or fraud rule. Accordingly, such triggers can be referred to with modifiers, e.g., limit trigger, threshold trigger, and fraud trigger. A trigger can be based on a numerical value limit, numerical value threshold, or a combination thereof. A trigger may be an if-then rule, where a positive determination of an event causes satisfaction of the rule, or a plurality of rules. Such events can include rates, i.e., a user customizable value per a customizable time period.

A “limit” is an event that causes the application of a “trigger” to stop an action or transaction. Limits can have, in some circumstances, multiple “values” that can be applied to the “trigger.”

A “threshold” is an event that causes the application of a “trigger” to report an action or transaction. Thresholds generally do not stop actions from occurring like the aforementioned limits. Thresholds can, in some circumstances, have multiple values that can be applied to the trigger. Typically the value set for a threshold must be less than the value set for a limit on the same trigger.

A “value” is any transactional or non-transactional aspect which may serve as a specific setting for a limit or threshold trigger. Typically, a “value” is a count or monetary (e.g., dollar, euro, yen, etc.) amount and, in some circumstances, a period of time. In some embodiments, a “value” can be a collection of specific events that happen in a time period (i.e., a velocity). These values can be applied to a trigger as limits or thresholds. Generally, the same count or amount part of a value cannot be used simultaneously as both a limit and a threshold unless the time period is different. In some embodiments, a value is representative can be non-monetary (e.g., award credits, points, airline miles, online game credits), which are used for exchange, and thus, like money, still transaction based. In some embodiments, a “value” is representative of a count of single occurrence of a specific action, and thus non-monetary and non-transactional. Examples of values include “3 cards ordered”, “3 new cards ordered/30 days”, “$500”, “$500/month”, “30000 miles”, “30000 miles/150 days”, “1000 points”, “1000 points/week”, etc.

A “case” is a fraud investigation, which is created when a fraud rule is activated and triggered, for example, by an enrollment, transaction, or profile change. In addition a “case” can be the end result of the possible configuration to create a case for a “limit” or “threshold” as part of these requirements.

An “account block” is an action to halt use of an account. An account block can be performed manually through an interface button. In addition an “account block” may be triggered upon opening a case if it has been configured to do so for a fraud rule, limit, or threshold as part of these requirements. For example, an account block of a teen program Account Holder blocks the account holder and associated teen cardholder accounts; an account block of a consumer or company buyer blocks only the buyer account; an account block of a cardholder account or join cardholder account blocks the cardholder account and underlying SVA.

I. Exemplary System:

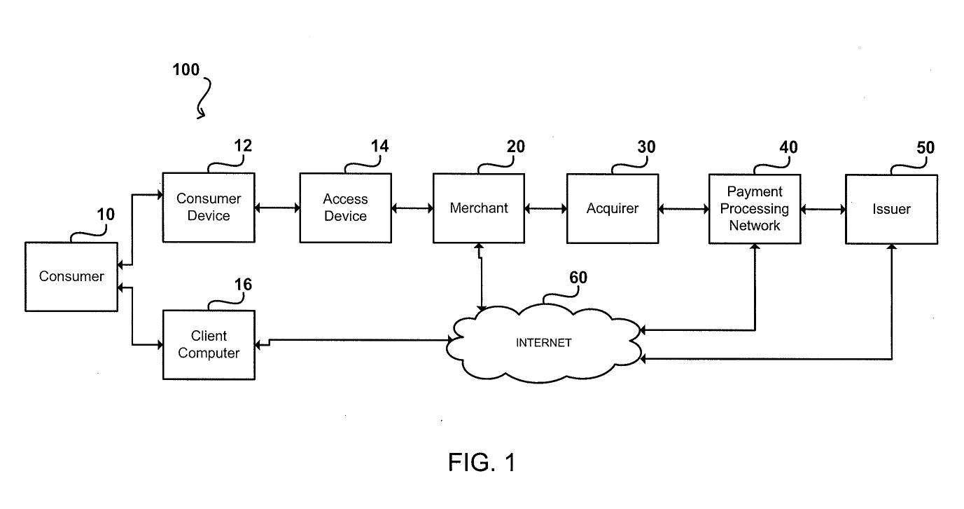

FIG. 1 shows a system 100 that can be used for conducting a payment transaction. The components in FIG. 1B may communicate via any suitable communication medium (including the internet), using any suitable communication protocol. System 100 can represent a standard payment request authorization model.

The system 100 includes a consumer 10 which may be an individual, or an organization such as a business that is capable of purchasing goods or services. The consumer 10 may operate a user computer 16. The user computer 16 can be a desktop computer, a laptop computer, a wireless phone, a personal digital assistant (PDA), etc., using any suitable operating system. The user computer may be used to interact with a merchant 20 (e.g., via a merchant website).

The consumer 10 may also be associated with a portable consumer device 12. A consumer account associated with the portable consumer device 12 may be used for purchase transactions. Embodiments of the portable consumer device 12 may be in any suitable form. For example, suitable portable consumer devices can be hand-held and compact so that they can fit into a consumer's wallet and/or pocket (e.g., pocket-sized). They may include prepaid cards, smart cards, ordinary credit cards (e.g., with a magnetic strip and without a microprocessor) such as payment cards, keychain devices (such as the Speedpass™ commercially available from Exxon-Mobil Corp.), etc. Other examples of portable consumer devices include cellular phones, personal digital assistants (PDAs), pagers, stored value cards, security cards, access cards, smart media, transponders, and the like.

The merchant 20 may be an individual or an organization such as a business that is capable of providing goods and services. The merchant 20 may have a computer apparatus. The computer apparatus may comprise a processor and a computer readable medium. The computer readable medium may comprise code or instructions for sending a transaction clearing request and receiving a clearing return code.

The merchant 20 may have one or more access devices 14. Suitable access devices 14 include interfaces and may include point of sale (POS) devices, cellular phones, PDAs, personal computers (PCs), tablet PCs, handheld specialized readers, set-top boxes, electronic cash registers (ECR), automated teller machines (ATM), virtual cash registers (VCR), kiosks, security systems, access systems, and the like. If the access device 14 is a POS terminal, any suitable POS terminal may be used and may include a reader, a processor, and a computer readable medium. A reader may include any suitable contact or contactless entry mode of operation. For example, exemplary card readers can include radio frequency (RF) antennas, optical scanners, bar code readers, magnetic stripe readers, etc. to interact with portable consumer device 12. As another alternative, a consumer 10 may purchase a good or service via a merchant's website where the consumer enters the credit card information into the user computer 16 and clicks on a button to complete the purchase. The user computer 16 may be considered an access device.

The system 100 also includes an acquirer 30 associated with the merchant 20. The acquirer 30 may be in operative communication with an issuer 50 of the consumer device 12 via a payment processing network 40. The acquirer 30 is typically a bank that has a merchant account. The issuer 50 may also be a bank, but could also be a business entity such as a retail store. Some entities are both acquirers and issuers, and embodiments of the invention include such entities. The acquirer 30 and the issuer 50 may each have a server computer and a database associated with the server computer.

The payment processing network 40 is located between (in an operational sense) the acquirer 30 and the issuer 50. It may include data processing subsystems, networks, and operations used to support and deliver authorization services, exception file services, and clearing and settlement services. For example, a payment processing network may include VisaNet™. Payment processing networks such as VisaNet™ are able to process prepaid card transactions, credit card transactions, debit card transactions, and other types of commercial transactions. VisaNet™, in particular, includes a VIP system (Visa Integrated Payments system) which processes authorization requests and a Base II system which performs clearing and settlement services.

The payment processing network 40 may use any suitable wired or wireless network, including the Internet 60. The payment processing network 40 may have a server computer and a database associated with the server computer. The server computer may comprise a processor and a computer readable medium. The computer readable medium may comprise code or instructions for the methods disclosed herein.

For simplicity of illustration, one consumer 10, one consumer device 12, one user computer 16, one access device 14, one merchant 20, one acquirer 30, and one issuer 50 are shown. It is understood, however, that embodiments of the invention may include multiple consumers, consumer devices, user computers, access devices, merchants, acquirers, and issuers. In addition, some embodiments of the invention may include fewer than all of the components shown in FIG. 1B.

In a typical transaction, a consumer 10 uses a consumer device 12 such as a prepaid card to interact with the access device 14 at the merchant 20. An authorization request message is generated by a processor in the access device 14 or and is sent to the payment processing network 40 via the acquirer 30. If the transaction is an online transaction, the user computer 16 can communicate with the merchant 20 via the Internet 60 and a computer at the merchant 20 can generate the authorization request message. Once received, the payment processing network 40 can perform appropriate fraud scoring and can send any fraud scores to the issuer 50 along with the authorization request message. Alternatively, the payment processing network 40 can simply deny the request of the fraud score indicates that the transaction is too risky.

If the authorization request message is approved by the issuer 50, the issuer 50 may generate an authorization response message that may be sent it back to the access device 14 or the user computer 16 via the payment processing network 40 and the acquirer 30.

At the end of the day or other time, a clearing and settling process can occur.

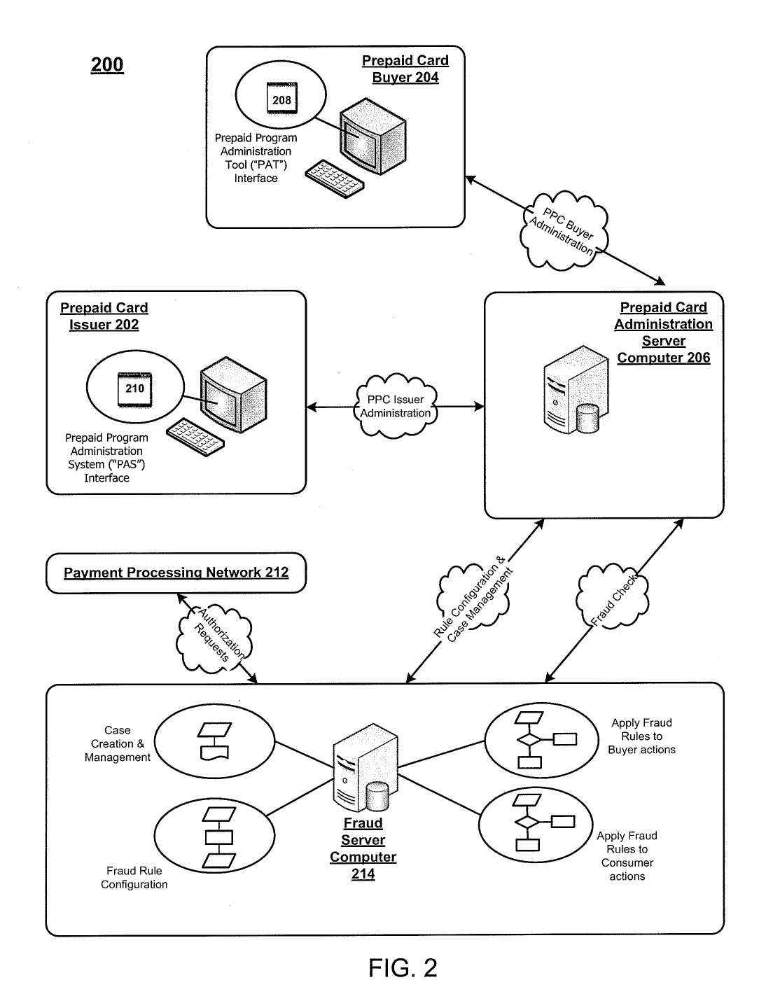

FIG. 2 shows a system 200, according to an embodiment of the invention. System 200 is used to manage various aspects related to prepaid cards. A prepaid card issuer 202, such as a banking institution, is authorized to issue prepaid cards to various buyers, such as prepaid card buyer 204. The prepaid card buyer 204 can be one of various entities, such as merchant or corporation. Prepaid cards that are purchased by the buyer 204 are intended to be used for transactions by cardholders, i.e., consumers, that obtain the prepaid cards through purchase or as gifts from the buyer 204. Prepaid cards are typically associated with a specific payment processing network (e.g., Visa™, American Express™).

The issuer 202 and buyer 204 can communicate with a prepaid card (“PPC”) administration server computer 206 via a private network (e.g., intranet) or public network such as the Internet. The buyer 204 uses a prepaid program administration tool (“PAT”) interface 208 to place orders for prepaid cards from the issuer 202 as well as for various administrative functions. The PAT interface 208 can be a graphical interface in the form of a secure webpage that is provided by the PPC administration server computer 206 and accessible via a browser (e.g., Internet Explorer™), or by a dedicated program stored and executed by a server computer of the buyer 204.

The issuer 202 uses a prepaid program administration system (“PAS”) interface 210 to manage administrative aspects for specific subsets/pluralities of cards issued to various users, such as buyer 204. The PAS interface 210 can also be used to configure custom fraud rules for specific users and to manage related fraud cases. The PAS interface 210 can be a graphical user interface provided in the form of a secure webpage that is provided by the PPC administration server computer 206 and accessible via a web browser (e.g., Internet Explorer™), or by a dedicated program stored and executed by a server computer of the issuer 202.

The PPC administration server computer 206 can be controlled by and part of a greater system of the issuer 202 or of another entity, such as a payment processing network 212 and partners/agents thereof. The PPC administration server computer 206 also can communicate with a fraud server 214 via a private network (e.g., intranet) or public network such as the Internet.

The fraud server computer 214 receives various direct and indirect instructions from the PPC administration server computer 206 related to prepaid payment card fraud detection, and in response performs methods to execute those instructions. For example, the fraud server computer 214 can configure fraud rules according to inputs made by the issuer at the PAS interface 210, create and manage fraud cases, and apply fraud rules to actions of the buyer 204, consumers, and combinations thereof. The fraud server computer 214 can also analyze prepaid card authorization requests supplied by the payment processing network 212 for fraud. The fraud server computer 214 can be controlled by and part of a greater system of the issuer 202 or of another entity, such as the payment processing network 212 and partners/agents thereof. The fraud server computer 214 and PPC administration server computer 206 can also be the same server computer.

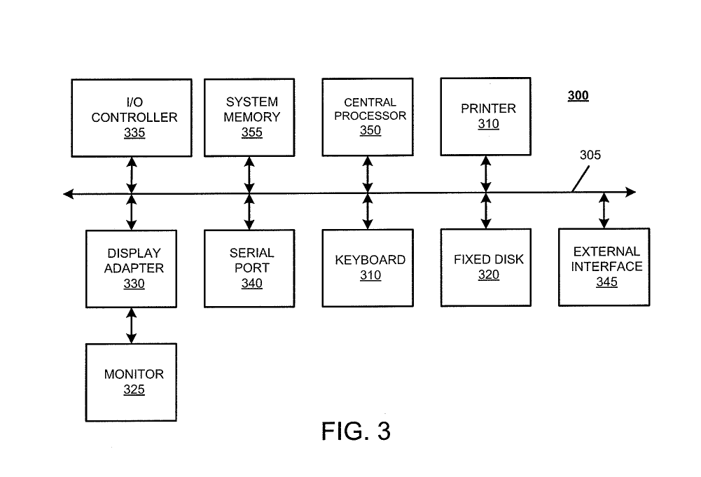

FIG. 3 is a high level block diagram of a computer apparatus 300 that may be used to implement any of the entities or components (e.g., user devices, server computers, etc.) described herein, which may include one or more of the subsystems or components shown in FIG. 3. The subsystems shown in FIG. 3 are interconnected via a system bus 305. Additional subsystems such as a printer 310, keyboard 315, fixed disk 320, monitor 325, which is coupled to display adapter 330, and others are shown. Peripherals and input/output (I/O) devices, which couple to an I/O controller 335, can be connected to the computer apparatus 300 by any number of means known in the art, such as serial port 340. For example, serial port 340 or external interface 345 can be used to connect the computer apparatus 300 to a wide area network such as the Internet, a mouse input device, or a scanner. The interconnection via the system bus 305 allows the central processor 350 to communicate with each subsystem and to control the execution of instructions from system memory 355 or the fixed disk 320, as well as the exchange of information between subsystems. The system memory 355 and/or the fixed disk 320 may embody a computer readable medium.

II. Exemplary Methods:

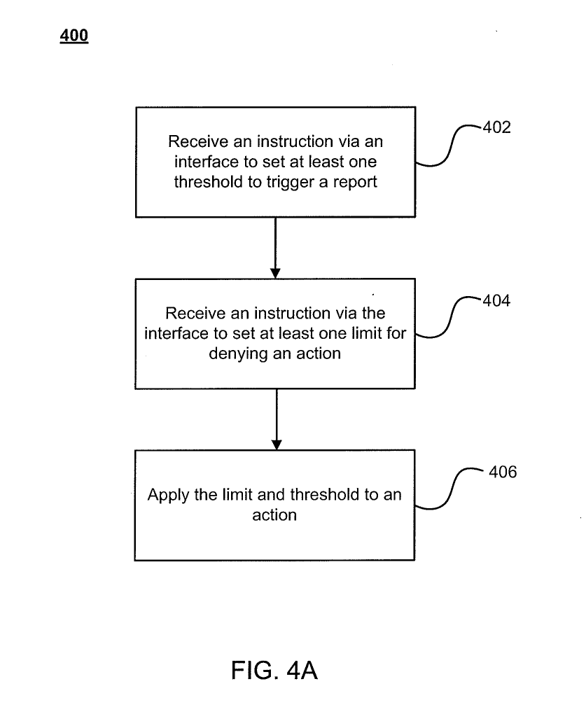

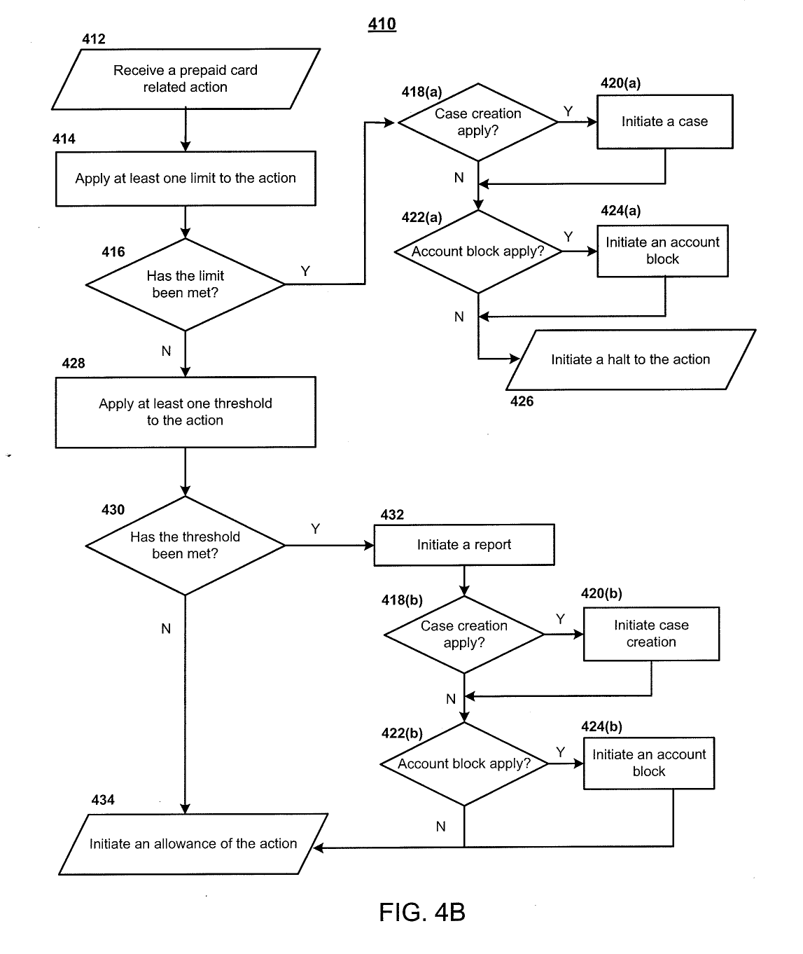

FIG. 4A shows a flowchart for a method 400, according to an embodiment of the invention. In some embodiments, machine instructions to perform the method 400 are stored on a computer readable medium and executable by, for example, a processor of a server computer, such as the fraud server computer 214, or by a system of interconnected processors of various server computers.

At operation 402, a rule processor receives instructions that are originally sourced from a user interface, such as the PAS interface 210 generated by a user processor in communication with the rule processor. The PAS interface 210 can be generated by porting the PAS interface 210 to the user processor from the rule processor. The instructions can be based on interface inputs made by the issuer 202. Here, the instructions relate to setting one or more thresholds, which when met or exceeded will cause a reporting action to occur, e.g., a report of the triggering events. Such thresholds can be, for example, a velocity or number of certain events by a buyer or cardholder.

Generally, a reporting action alone does not result in any other immediate action other than a report to be created and sent to a prepaid card issuer and/or another entity, such as a payment processing network. However, additional actions can be configured via the interface to occur when thresholds are triggered. For example, a fraud case can be created, which requires a follow-up investigation of the triggering event. In another example, a more immediate action can be configured, such as blocking a related account from further use.

At operation 404, the rules processor receives instructions sourced from the user processor via the interface that relate to setting one or more limits, which when met or exceeded will cause a related action, such as a transaction authorization request, to be halted/denied. As in operation 402, these instructions are originally sourced from the user interface. Further actions can be configured to occur as well. For example, a fraud case can be created and/or a related account can be blocked from further use.

At operation 406, the threshold and limit are applied to an action by a fraud processor, such as a prepaid card transaction or prepaid card purchase order. The threshold and limit can be customized by the issuer via the interface to apply to only a specific buyer's account and associated prepaid cards, and subsets thereof.

FIG. 4B shows a method 410 for applying a fraud rule to a prepaid card action, according to an embodiment of the invention. In some embodiments, machine instructions to perform method 410 are stored on a computer readable medium and executable by, for example, a processor of a server computer, such as the fraud server computer 214, and/or by a system of interconnected processors of various server computers. In some embodiments, method 410 can be an aspect of operation 406 of method 400.

At operation 412, an action related to a prepaid card is received in order to be analyzed for fraudulent activity. In some embodiments, such an action can be performed by a prepaid card buyer. For example, the action can be a commercial bulk purchase order for a large amount of prepaid cards or a consumer purchase for a gift cards. In other embodiments, such an action can be a managerial request originating from a cardholder, such as a transaction, reload request, or replacement card request. In other embodiments, such an action can be a test to determine the effectiveness of a fraud rule-set against known fraudulent and non-fraudulent actions.

At operation 414, the action is analyzed to determine whether a predefined limit applies to the transaction. For example, a transactional spending limit, a per card-value purchase order limit, a total purchase order limit, amount of cards limit, and various other limits and/or combinations of limits. Limits can be predefined by an issuer using embodiments of the PAS interface described herein.

At operation 416, at least one limit has been found to apply to the action from operation 414 and it is further determined whether at least one applicable limit is met or exceeded. The method 410 moves to operation 418(a) when at least one applicable limit is met or exceeded.

At operation 418(a), it is determined whether a case can be created according to the triggered limit. Cases can be created according to optional inputs made by the issuer using embodiments of the PAS interface described herein. Case creation is initiated in operation 420(a) by directly creating the case or by sending related information to another server computer that is configured to create the case.

At operation 422(a), it is determined whether an account related to the triggered limit can be blocked from further use. Account blocking can occur according to optional inputs made by the issuer using embodiments of the PAS interface described herein. Account blocking is initiated in operation 424(a) by directly blocking the account or by sending related information to another server computer that is configured to block the account.

At operation 426, the initiation of a halt to the action occurs. This may be done by directly halting the action or by sending related information to another server computer that is configured to halt the action.

It can be understood that, in some embodiments, operations 418(a) and 422(a) are optional, accordingly, the method 410 can proceed from operation 416 to operation 422(a) without applying operation 418(a). Likewise, the method 410 can proceed from operation 418(a) to operation 426 without applying operation 422(a). Again, likewise, the method 410 can proceed from operation 416 to operation 426 without applying operations 418(a) and 422(a).

The method 410 moves from operation 416 to operation 428 when no applicable limit is met or exceeded. At operation 428, the action is analyzed to determine whether a predefined threshold applies to the transaction. For example, a transactional spending threshold, a card-value purchase order threshold, an amount of cards purchased threshold, and various other limits and/or combinations of thresholds. Thresholds can be predefined by an issuer using embodiments of the PAS interface described herein.

At operation 418(b), it is determined whether a case can be created according to the triggered limit. Cases can be created according to optional inputs made by the issuer using embodiments of the PAS interface described herein. Case creation is initiated in operation 420(b) by directly creating the case or by sending related information to another server computer that is configured to create the case.

At operation 422(b), it is determined whether an account related to the triggered limit can be blocked from further use. Account blocking can occur according to optional inputs made by the issuer using embodiments of the PAS interface described herein. Account blocking is initiated in operation 424(b) by directly blocking the account or by sending related information to another server computer that is configured to block the account.

At operation 434, an indication that the action may proceed is provided. This may be done by directly allowing the action or by sending related information to another server computer that is configured to allow the action.

It can be understood that, in some embodiments, operations 418(b) and 422(b) are optional, accordingly, the method 410 can proceed from operation 432 to operation 422(b) without applying operation 418(b). Likewise, the method 410 can proceed from operation 418(b) to operation 442 without applying operation 422(b). Again, likewise, the method 410 can proceed from operation 432 to operation 442 without applying operations 418(b) and 422(b).

III. Exemplary Interface:

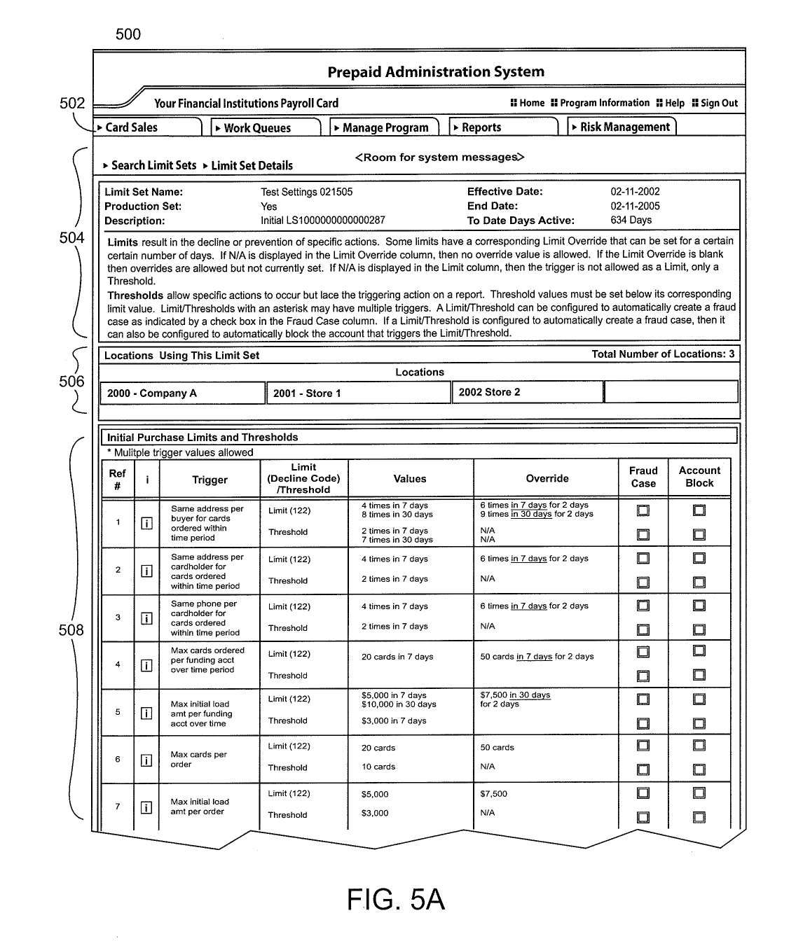

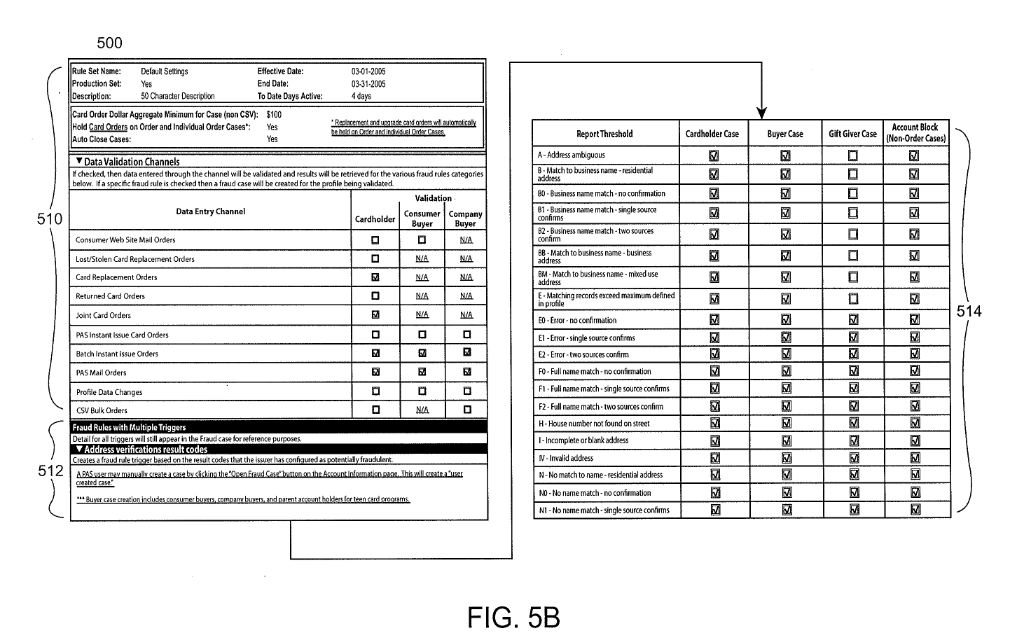

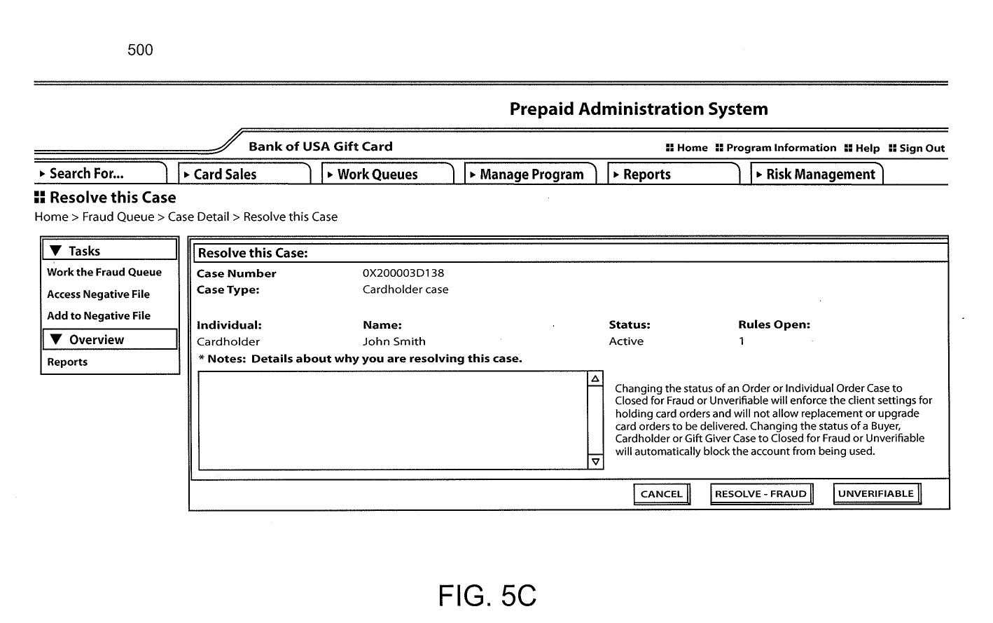

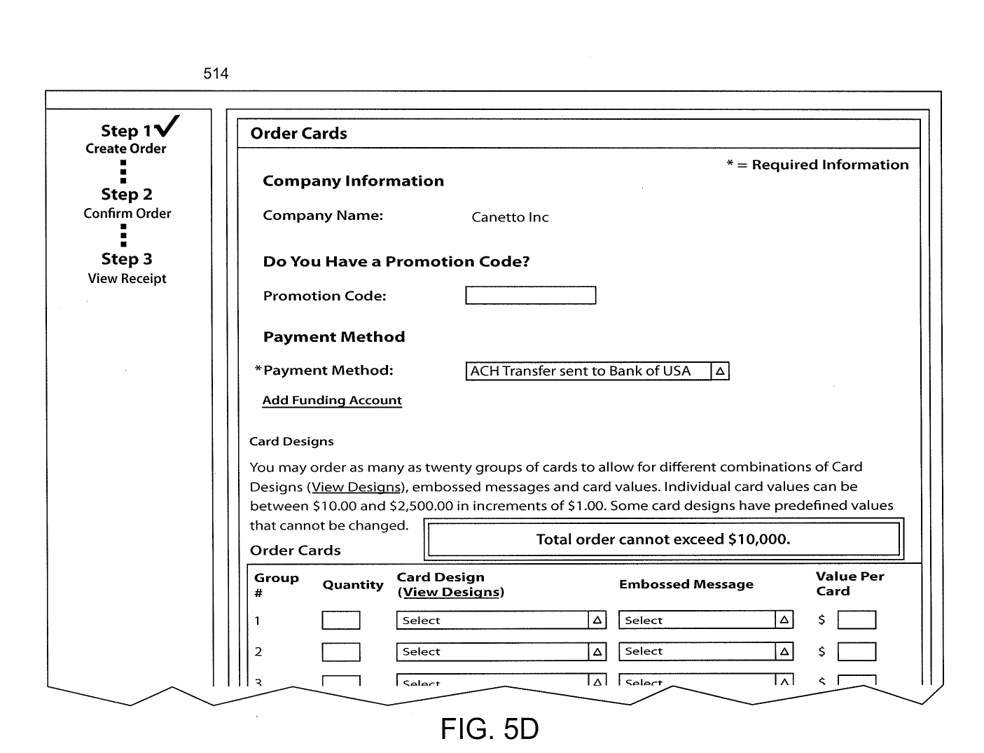

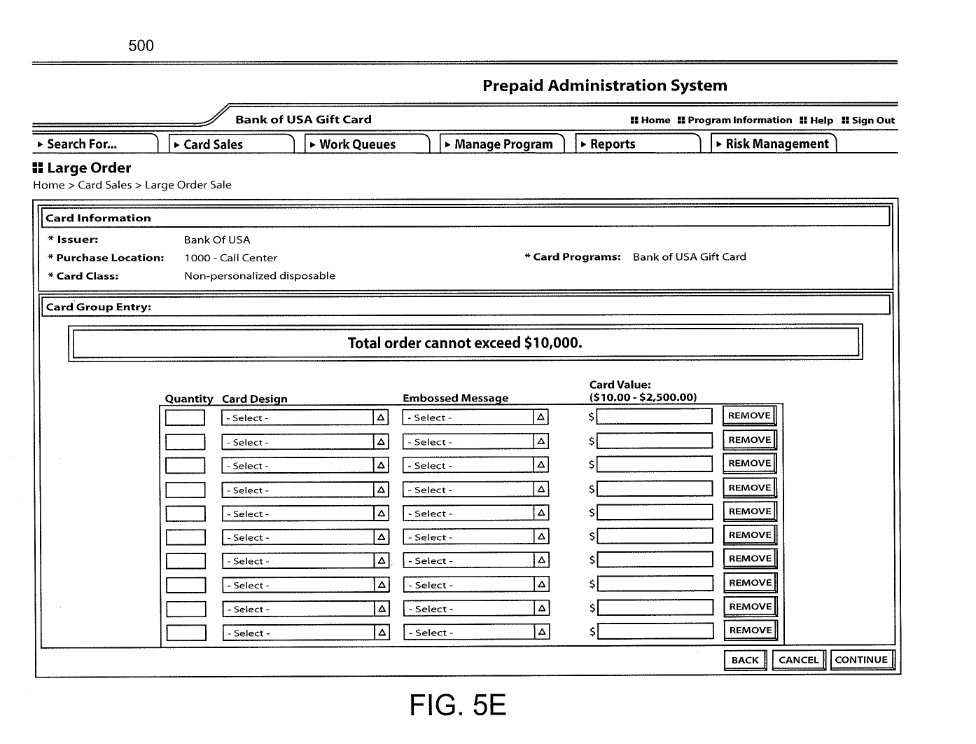

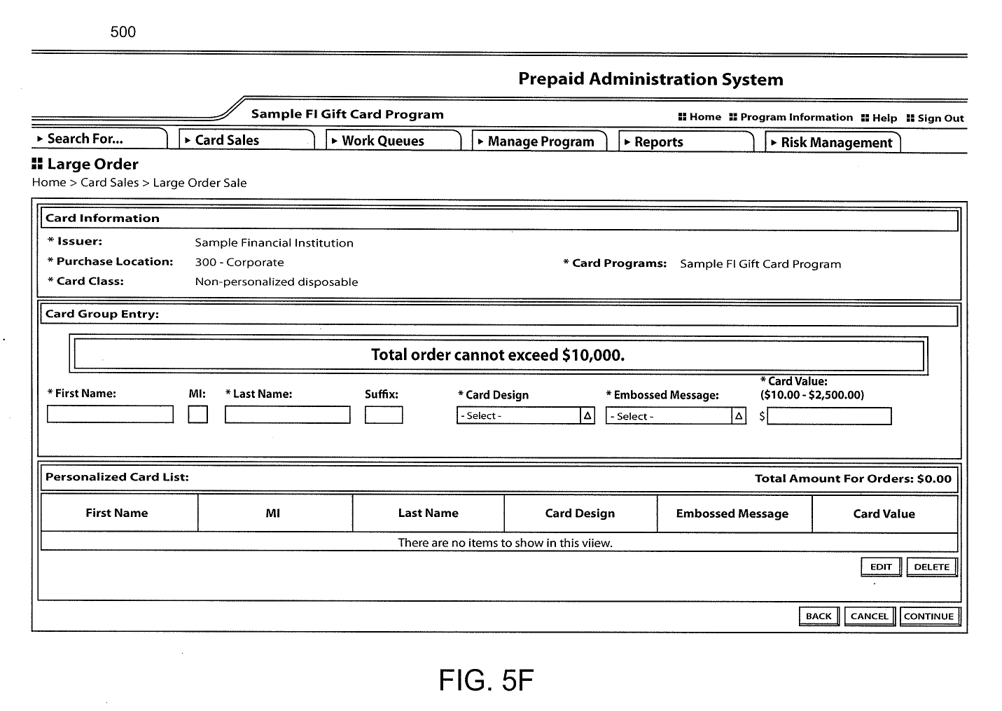

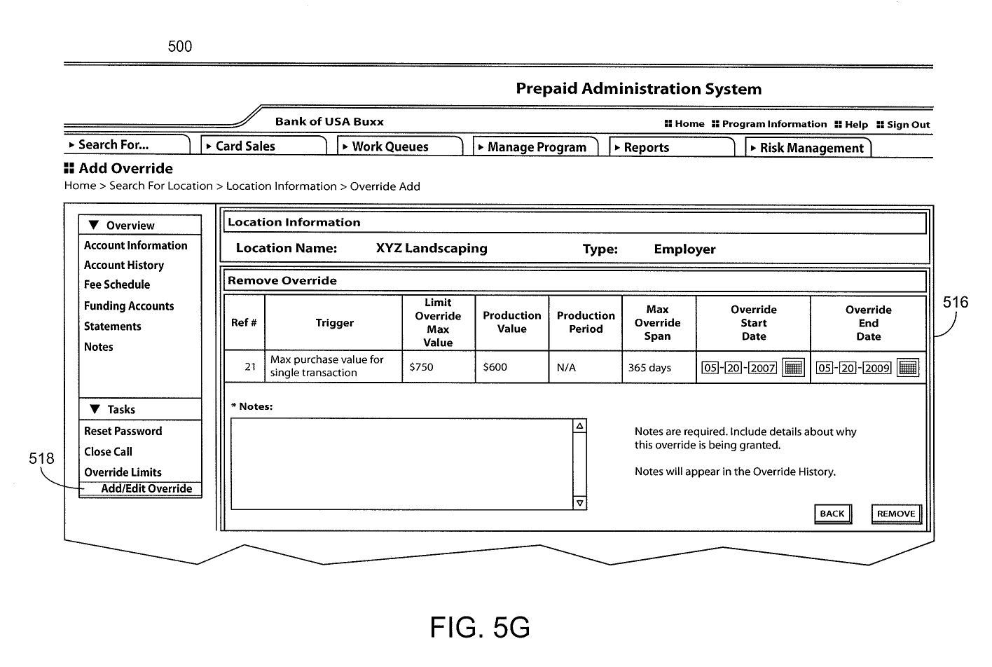

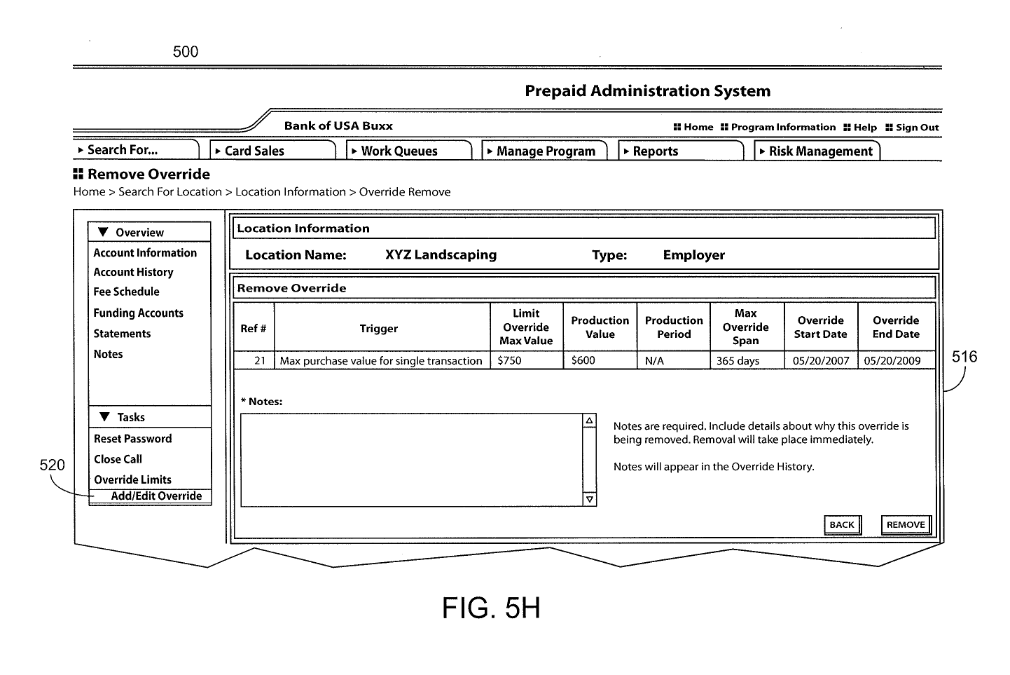

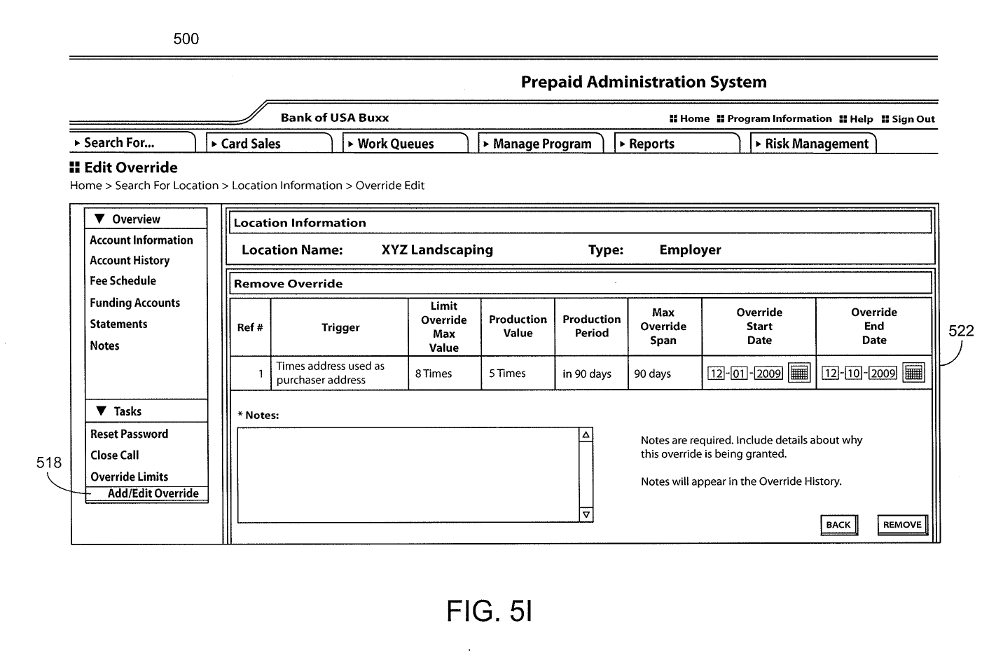

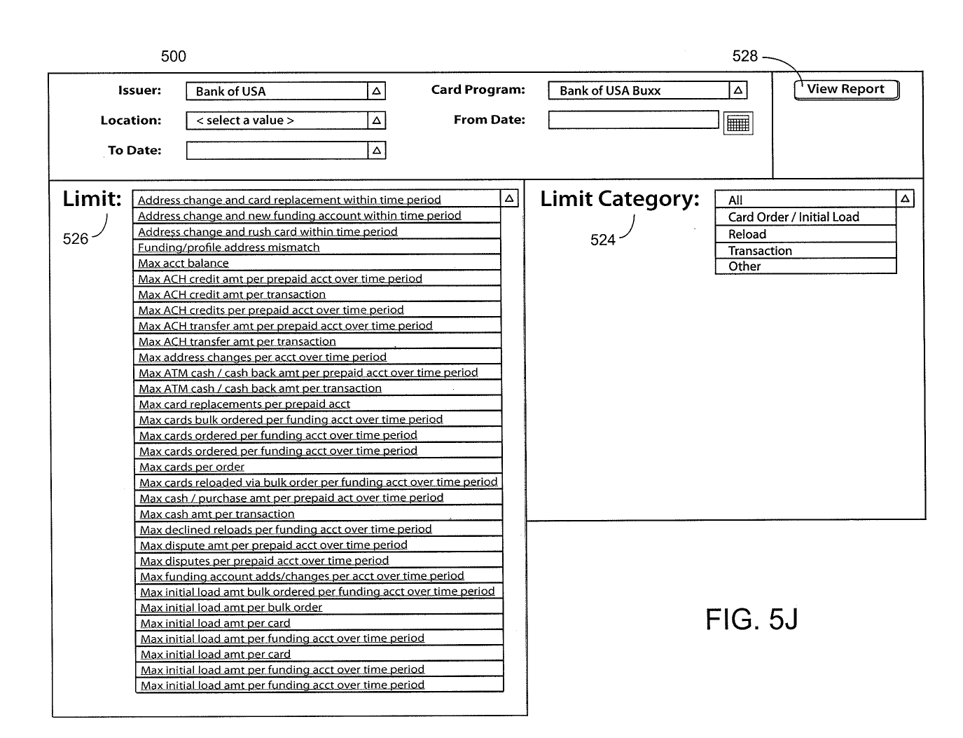

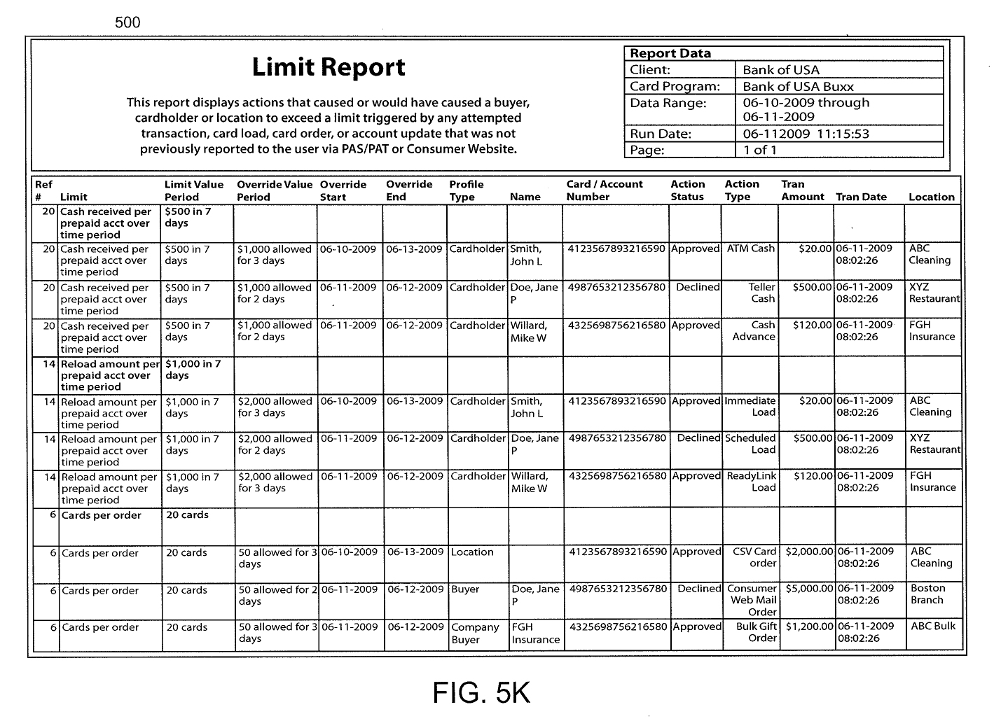

FIG. 5A shows a screen shot of an prepaid administration system (“PAS”) interface 500, according to an embodiment of the invention. The PAS interface 500 may be provided in the form of a secure web page hosted by a payment processing network and accessible on a private (e.g., intranet) or public network (e.g., Internet). Alternatively, the PAS interface 500 may be a dedicated software application on a user computer of an issuer. Typically, a pointing device, such as a mouse, is used to interact with the PAS interface 500, along with a keyboard.

The PAS interface 500 includes a plurality of selectable tabs 502 (e.g., Card Sales, Work Queues, Manage Program, Reports, Risk Management) for selecting a particular sub-interface to interact with. In this view, a “View Limit Set” page is shown. An upper portion 504 of the PAS interface 500 displays rule details for a set of limit/threshold rules. Such details can include a limit set names, descriptors, and related implementation dates. At portion 506 location information is displayed. Location information includes details related to where rule sets are applicable to, e.g., the rule set show in upper portion 504 would be applicable to a card order sent from “Company A”.

Lower portion 508 of the PAS interface 500 displays details for individual rules of the rule set. Such details include a reference number, information icon, rule trigger description, related codes, trigger values, rule override values, fraud case boxes, and account block boxes. For example, viewing from left to right of the PAS interface 500, a rule indicated as Ref #1 (fraud rule 1) has a trigger of “same address per buyer for cards ordered within time period”, which means that when the same address is used in conjunction with a certain purchasing velocity, then the rule is triggered. Here, a limit is set for 4 purchase/7 days or 8 purchases/30 days, and a threshold is set for 2 purchases/7 days or 7 purchases/30 days.

The rules can be overridden in certain circumstances, and according to one or more defined instances configurable via the PAS interface 500. Here, for fraud rule 1, if 4 purchases/7 days occurs, then a limit rule will not be triggered if 6 purchases in the 7 day period are confined to 2 days. Similarly, the limit will not be triggered if 9 purchases in 30 days are confined to 2 days.

FIG. 5B shows another screen shot of the PAS interface 500, according to an embodiment of the invention. In this view, the PAS interface 500 displays information related to data validation channels in portion 510. Here, various validation boxes can be checked to cause PPC related events received from a particular data entry channels to be validated according to chosen rule sets, and according to the type of entity causing the event. For example, PPC purchases corresponding to “consumer web site mail orders” can be validated according to the type of entity, i.e., a cardholder/consumer, consumer buyer, or company buyer causing the event. Here, no validation boxes are checked, and accordingly events received via consumer web site mail orders will not be scrutinized. As shown, certain events need not apply to certain entities, e.g., actions of a company buyer would not applicable to consumer web site mail order. Other validation channels can include “Lost/Stolen Card Replacement Orders”, “Card Replacement Orders”, “Returned Card Orders”, “Joint Card Orders”, “PAS Instant Issue Card Orders”, “Batch Instant Issue (Card Order File and Card Add Batch) Orders, “Instant Issue Replacement Orders, “PAS Mail Orders”, “PAS Large Company Personalized Orders”, “PAS Large Company Non-Personalized Orders”, “CSV Bulk Orders”, “Bulk (CSV and Card Order File) Mail Orders”, “Batch (Large Company and CSV) Mail Orders”, and “Profile Data Changes (Consumer Buyer includes Teen Gift Giver)”.

A mid-portion 512 of the PAS interface 500 shows result codes for threshold triggering events related to address verifications. A user may configure a rule to create a case according to various types of entities responsible for the triggering action. Rules can be configured according to predefined triggers selected to apply to specific entities. Here, boxes can be clicked to check the box and associate an entity with a trigger. For example, code “A” relates to a threshold trigger showing an ambiguous address. A case will be created when the trigger is caused by a cardholder or buyer, as shown by the checked boxes, but not a gift giver, as shown by the unchecked box. Additionally, an associated account will be blocked from further use.

FIG. 5C shows another screen shot of the PAS interface 500, according to an embodiment of the invention. In this view, the PAS interface 500 displays a “Resolve This Case” page. A user can interact with this portion of the PAS interface 500 to resolve a case created by a fraud rule. The user can resolve the case to be a fraudulent activity or classify the case as unverifiable. A notes section allows the user to enter text regarding reasons for why the case was resolved.

FIG. 5D shows a screen shot of a consumer web site 514, according to an embodiment of the invention. The consumer web site 514 enables a buyer to purchase gift cards. The PAS interface 500 can configure rules according to purchases made from the consumer web site 514. For example, a trigger can be configured according to a maximum bulk order per funding account over a predefined time period, a maximum initial load amount that is bulk ordered per funding account over a predefined time period, and a maximum initial load amount per bulk order. Rules can affect a single order, or multiple orders in tandem.

FIGS. 5E and 5F show screen shots of the PAS interface 500, according to embodiments of the invention. The screen shot of the PAS interface 500 shown in FIG. 5E is for standard bulk company orders, and the screen shot of the PAS interface 500 shown in FIG. 5F is for personalized bulk company orders. The PAS interface 500 displays an ordering screen for bulk company orders. Certain triggers may apply specifically to large company orders. For example, a trigger can be configured according to a maximum bulk order per funding account over a predefined time period, a maximum initial load amount that is bulk ordered per funding account over a predefined time period, and a maximum initial load amount per bulk order.

FIGS. 5G, 5H, and 5I show screen shots of the PAS interface 500, according to an embodiment of the invention. In these views, the PAS interface 500 displays information related to specific types of triggers that are applicable to one location. For example at portion 516 information relating to a “Max purchase value for single transaction” trigger is displayed. In FIG. 5G a user can add a new trigger override by making an override-add selection at portion 518, which may be a pull-down menu item, to enable the PAS interface 500 to make override additions. Predefined override values can be provided by the PAS interface 500. Values for the override are enterable by the user, for example, a max value, a production value, maximum time span, and start and end dates. A notes section is provided where the user can enter text to describe why the particular override is being added.

In FIG. 5H the user can remove an override in a similar manner as shown in FIG. 5G, by making an over-ride remove selection at portion 520, which may be a pull down-menu item. Justification for removing the override can be provided by the user in a notes portion.

In FIG. 5I the user can edit an override shown in portion 522 related to a “Times address used as purchaser address” trigger, by selecting portion 518 to enable the PAS interface 500 to edit an existing override. Accordingly, the user can then make changes to exiting override values.

FIG. 5J shows another screen shot of the PAS interface 500, according to an embodiment of the invention. In this view, the PAS interface 500 displays information related to creating a PAS limit report. Such a report can be configured by various drop down parameters, for example for selecting one or more issuers, locations, card programs, and dates. A limit category pull down tab 524 is shown to include limit categories such as all limits, card order/initial load, reload, transaction, and other. A limit drop down tab 526 is shown to include all currently active limits. After all the desired selections are made, the user can select portion 528 to view the report.

FIG. 5K shows another screen shot of the PAS interface 500, according to an embodiment of the invention. In this view, the PAS interface 500 displays a limit report created by user interaction with the PAS interface as shown in FIG. 5J. The report is configured to display actions that caused or would have caused a buyer, cardholder or location to exceed a limit triggered by a related act.

IV. Exemplary Triggers:

A trigger is the high-level rule that is evaluated when determining whether to apply a limit, threshold or fraud rule. Accordingly, such triggers can be referred to with modifiers, e.g., limit trigger, threshold trigger, and fraud trigger. A trigger can be based on a numerical value limit, numerical value threshold, or a combination thereof. A trigger may be an if-then rule, where a positive determination of an event causes satisfaction of the rule, or a plurality of rules. Such events can include a user customizable value per a customizable time period or event, made via the PAS interface 500. Exemplary triggers are listed in the table below:

TABLE I
“Address change and card replacement within time period”.
“Address change and rush card within time period”.
“Same address per buyer for cards ordered within time period”.
“Same address per buyer/cardholder for cards ordered within time period”.
“Same address per cardholder for cards purchased within time period”.
“Max card replacements per prepaid acct”.
“Max cards per order”.
“Max cards ordered per funding acct over time period”.
“Max cards bulk ordered per funding acct over time period”.
“Same Govt ID per buyer for cards ordered within time period”.
“Same Govt ID per buyer/cardholder for cards ordered within time
period”.
“Same Govt ID per cardholder for cards ordered within time period”.
“Max initial load amt per bulk order”.
“Max initial load amt per card”.
“Max initial load amt per funding acct over time period”.
“Max initial load amt per order”.
“Max initial load amt bulk ordered per funding acct over time period”.
“Min initial load amt per card”.
“Name and address change and card replacement within time period”.
“Name and address change and rush card within time period”.
“Name change and card replacement within time period”.
“Name change and rush card within time period”.
“Same phone per buyer for cards ordered within time period”.
“Same phone per buyer/cardholder for cards ordered within time period”.
“Same phone per cardholder for cards ordered within time period”.
“Max acct balance”.
“Max ACH credit amt per prepaid acct over time period”.
“Max ACH credit amt per transaction”.
“Max ACH credits per prepaid acct over time period”.
“Max cards reloaded via bulk order per funding acct over time period”.
“Max declined reloads per funding acct over time period”.
“Max load amt per funding acct over time period”.
“Min ACH credit amt per transaction”.
“Min amt per reload”.
“Min money transfer amt from another person per transaction”.
“Min money transfer amt received per transaction”.
“Min load amt per transaction”.
“Max money transfer amt from another person over time period”.
“Max money transfer amt from another person per transaction”.
“Max money transfer amt received per prepaid acct over time period”.
“Max money transfer amt received per transaction”.
“Max money transfers from another person over time period”.
“Max money transfers received per prepaid acct over time period”.
“Max load amt per prepaid acct over time period”.
“Max load amt per transaction”.
“Max amt of loads per prepaid acct over time period”.
“Max reload amt per funding acct over time period”.
“Max reload amt per prepaid acct over time period”.
“Max reload amt per transaction”.
“Max reload amt bulk ordered per funding acct over time period”.
“Max reload amt per bulk order”.
“Max reloads per funding acct over time period”.
“Max reloads per prepaid acct over time period”.
“Max ACH transfer amt per prepaid acct over time period”.
“Max ACH transfer amt per transaction”.
“Max ATM cash/cash back amt per prepaid acct over time period”.
“Max ATM cash/cash back amt per transaction”.
“Max cash/purchase amt per prepaid acct over time period”.
“Max cash amt per prepaid acct over time period”.
“Max cash amt per transaction”.
“Max intl transactions per prepaid acct over time period”.
“Max teller cash amt per prepaid acct over time period”.
“Max teller cash amt per transaction”.
“Min ACH transfer amt per transaction”.
“Min money transfer amt to another person per transaction”.
“Min money transfer amt sent per transaction”.
“Max money transfer amt to another person over time period”.
“Max money transfer amt to another person per transaction”.
“Max money transfer amt sent per prepaid acct over time period”.
“Max money transfer amt sent per transaction”.
“Max money transfers to another person over time period”.
“Max money transfers sent per prepaid acct over time period”.
“Max negative balance per prepaid acct”.
“Max purchase amt per prepaid acct over time period”.
“Max purchase amt per transaction”.
“Max purchase return amt per prepaid acct over time period”.
“Max purchase return amt per transaction”.
“Max address changes per acct over time period”.
“Max dispute amt per prepaid acct over time period”
“Max disputes per prepaid acct over time period”
“Funding acct adds/changes per acct over time period”
“Funding/profile address mismatch”
“Negative file data match”
“Address change and new funding account within time period”
“User created case”
“Max load amt per funding acct over time period”
“Max cards bulk ordered per funding acct over time period”
“Max initial load amt bulk ordered per funding acct over time period”
“Max initial load amt per bulk order”

In some embodiments, a user configurable “Max purchase return amt per transaction aka Prepaid Account Velocity” trigger is provided to affect, for example, purchase return transactions. For reloadable programs, the Threshold can have a single configurable value for the dollar amount of a purchase return transaction. (i.e. $75.00). For disposable programs, the Threshold can have a single configurable value for the dollar amount of a purchase return transaction with an additional option to choose the “initial card value” (For example, if a user has a disposable gift card program, and the card is issued for $100, then they could set the threshold to trigger if a prepaid account receives a purchase return for a set amount such as $75 or more or they could set the threshold to trigger if a prepaid account receives a purchase return for the initial load value of $100 or more). The Threshold can allow a single trigger value (e.g., $300.00 or initial card value for a disposable program). The Threshold can trigger when the dollar amount of a single purchase return transaction is greater than the dollar amount value set by the user for the program or sub-user.

In some embodiments, a user configurable “Negative File Data Match Fraud” trigger is provided. The threshold trigger can trigger when a card purchase or data change uses data that matches data on the User's Negative File.

In some embodiments, a user configurable “Funding/profile address mismatch” trigger is provided. A threshold can trigger when a billing address for a funding account is added or changed on the consumer site, PAT or PAS that does not “match” the profile address of the buyer, gift giver, account holder or cardholder that is adding the funding account.

In some embodiments, a user configurable “Address change and new funding acct within time period” is provided. A threshold can trigger when a user changes or updates their profile address and then adds a funding account within a certain period of time. If the funding account is added prior to the profile address change or update then the Threshold can not be triggered.

In some embodiments, a user configurable “Max purchase return amt per prepaid acct over time period” trigger is provided. The trigger can be available for all card programs with the ability to be activated as part of a program-level Limit Set that can be overridden at the sub-user level (Program Limit Set). For reloadable prepaid programs, the threshold can have multiple configurable values for the dollar amount of a purchase return transaction and a configurable number of days that represents the time period for aggregating the dollar amount of purchase return transactions to the prepaid account (i.e. $300.00 in 7 days and $1,000.00 in 30 days). For disposable prepaid programs, the threshold can have multiple configurable values for the dollar amount of a purchase return transaction with an additional option to choose the “initial card value” and a configurable number of days that represents the time period for aggregating the dollar amount of purchase return transactions to the prepaid account (e.g., if a user has a disposable gift card program, and the card is issued for $100, then they could set the threshold to trigger if a prepaid account receives a purchase return for a set amount such as $75 or more in 7 days or they could set the threshold to trigger if a prepaid account receives a purchase return for the initial load value of $100 or more in 7 days).

The threshold can trigger when an aggregate dollar amount of purchase return transactions to a prepaid account during the time period set by the user is greater than the dollar amount value. For example, an ABC Gift program has a purchase return amount threshold set for $400 in 7 days. Someone buys a $500 ABC Gift card and gives it to the cardholder. A purchase return transaction is force posted for $300 on Jul. 1, 2009. A second purchase return transaction is force posted for $150 on Jul. 3, 2009. Since the two purchase return transactions occurred within 7 days of each other and they total more than the $400 threshold value, the second transaction would trigger the threshold. If the user has configured the threshold to automatically open a fraud case then a fraud case would be opened. If the user configured the threshold to also automatically block the account, then the account would also be blocked.

Triggers can be configurable within a Program Limit Set to automatically open a Case. If other Limits, Thresholds and Fraud Rules that are configured to open a case are triggered by the same action, then only one case may be opened that lists all of limits, thresholds and fraud rules that were triggered by the action, which is the existing functionality for multiple rule trigger events. If a subsequent action triggers the same or different limits, thresholds and fraud rules that are configured to create a case after a case has already been created, then a new case may be opened unless the existing fraud case on the account is in “Open” or “Unverifiable” status. If the existing case is in “Open” or “Unverified” status and a subsequent action triggers a case, then the Trigger or Fraud Rule from the most recent action can be added as a “Rule Triggered” to the most recent existing case instead of opening a new case. If a Trigger or Fraud Rule that is configured to open a case is triggered and added to an existing case in “Open” or “Unverified” status, then the assignment of the case can either remain “unassigned” or be changed from whatever User ID is assigned to the case to “unassigned”.

Triggers can be configurable within a Program Limit Set to automatically “Block account” on the cardholder account including joint cardholder accounts. Users can be able to configure the threshold to open a case and block the card or just open a case only. In some embodiments, users can not be able to configure the new Threshold to block the account without also creating a case.

In some embodiments, a user configurable “Max negative balance per prepaid acct” trigger is provided. A threshold trigger may have a single configurable value for the negative dollar amount of the prepaid account balance (e.g., −$10.00). The threshold can trigger when the balance of a prepaid card account goes below a dollar amount value set by the user as a result of a financial transaction (fees or other non-financial transactions that cause the balance of the account to go below the threshold can not trigger the threshold). For example, ABC Gift program has a negative balance threshold set for −$10.00. An ABC gift card has a balance of $10.00 when a transaction is force posted for $60.00. Since this transaction puts the card's account balance further negative than the −$10.00 threshold, the transaction would trigger the threshold. If the user has configured the threshold to open a fraud case, then, accordingly, a fraud case would be opened. If the user configured the threshold to also automatically block the account, then the account would also be blocked.

In some embodiments, a user configurable “Name change and card replacement within time period” trigger is provided. The threshold can have a single count value of two (name change+card replacement) for the combination of a cardholder profile name change (first, last or both) and a card replacement order (lost, stolen or damaged) on a prepaid account and the number of days that represents the time period for this combination of actions (i.e. “Both occur in 7 days”). The threshold can trigger when the combination of a cardholder profile name change and a card replacement (lost, stolen or damaged) order both occur on a prepaid account during the time period set by the user. For example, ABC Gift program has a Name Change and Card Replacement threshold set if both occur within a 30 day period. ABC gift cardholder goes online and changes the cardholder name in the profile from Mark Smith to John Smith on Jul. 1, 2009. On Jul. 15, 2009, the cardholder talks to a CSR and reports the card damaged and asks for the card to be replaced and shipped normal delivery. Since the name change and card replacement both occur within 30 days, the action would trigger the threshold.

In some embodiments, a user configurable “Address change and card replacement within time period” trigger is provided. The threshold can have a single count value of two (address change+card replacement) for the combination of a cardholder profile address change and a card replacement (lost, stolen or damaged) order on a prepaid account and the number of days that represents the time period for this combination of actions (e.g., “Both occur in 7 days”). The threshold can trigger when it is active for a program or sub-user and the combination of a cardholder profile address change and a card replacement (lost, stolen or damaged) order both occur on a prepaid account during the time period set by the user. For example, ABC Gift program has an Address Change and Card Replacement threshold set if both occur within a 30 day period. ABC gift cardholder goes online and changes the cardholder address in the profile from “123 Main St” to “987 South St” on Jul. 1, 2009. On Jul. 15, 2009, the cardholder talks to a CSR and reports the card damaged and asks for the card to be replaced and shipped normal delivery. Since the address change and card replacement both occur within 30 days, the action would trigger the threshold.

In some embodiments, a user configurable “Name and address change and card replacement within time period” trigger is provided. The threshold can have a single count value of three (name change+address change+card replacement) for the combination of a cardholder profile name change (first, last or both) and cardholder profile address change and a card replacement (lost, stolen or damaged) order on a prepaid account and the number of days that represents the time period for this combination of actions (e.g. “All occur in 7 days”). The threshold can trigger when it is active for a program or sub-user and the combination of a cardholder profile name change and a cardholder profile address change and a card replacement (lost, stolen or damaged) order all occur on a prepaid account during the time period set by the user. For example, ABC Gift program has a Name and Address Change and Card Replacement threshold set if all occur within a 30 day period. ABC gift cardholder goes online and changes the cardholder address in the profile from “123 Main St” to “987 South St” and changes the cardholder name from “Mark Smith” to “John Smith” on Jul. 1, 2009. On Jul. 15, 2009, the cardholder talks to a CSR and reports the card damaged and asks for the card to be replaced and shipped normal delivery. Since the name and address change and card replacement both occur within 30 days, the action would trigger the threshold.

In some embodiments, a user configurable “Same government ID per cardholder for cards ordered within time period” trigger is provided. The trigger can affect all card orders through mail orders, instant issues, and large company orders. Limit and threshold triggers can have multiple configurable values for the number of times the same government ID can be used in the cardholder profile of a prepaid card purchase and the number of days that represents the time period of card purchases (i.e. limit of 3 times in 7 days and threshold of 2 times in 7 days and limit of 10 times in 30 days and threshold of 8 times in 30 days). The limit and threshold can trigger when the aggregate number of times the same government ID is used in the cardholder profile of a prepaid card purchased during the time period set by the user is greater than the number value set by the user for the program or sub-user. For example, XYZ GPR program has a limit set to 2 card purchases with the same Govt ID used in the cardholder profile within 365 days and a threshold set for 1 time in 365 days. A card is purchased and registered with “123-45-6789” as the SSN on Jul. 1, 2009. On Oct. 1, 2009, another XYZ GPR card is purchased with a cardholder profile using “123-45-6789” as her SSN. Since this is the second time a card has been purchased with the same SSN within a 365 day period, the card purchase from Oct. 1, 2009 would trigger the threshold and display on the threshold reports. On Mar. 1, 2010, a third person attempts to purchase an XYZ GPR card using “123-45-6789” as his SSN. Since this is the third attempted card purchase with the same SSN, the limit is triggered and the card purchase is declined.

In some embodiments, a user configurable “Same government ID per buyer for cards ordered within time period” trigger can be provided. Limit and threshold triggers can have multiple configurable values for the number of times the same government ID can be used in the buyer profile of a prepaid card purchase and the number of days that represents the time period of card purchases (e.g. limit of 3 times in 7 days and threshold of 2 times in 7 days and limit of 10 times in 30 days and threshold of 8 times in 30 days). Buyer profiles can include buyers, account holders and gift givers. The limit and threshold can trigger when an aggregate number of times the same government ID is used in the buyer profile of a prepaid card purchased during the time period set by the user is greater than the number value set by the user for the program or sub-user. For example, XYZ GPR program has a limit set to 2 card purchases with the same government ID used in the buyer profile within 365 days and a threshold set for 1 time in 365 days. A buyer purchases a card with “123-45-6789” as the SSN on Jul. 1, 2009. On Oct. 1, 2009, another XYZ GPR card is purchased with a buyer profile using “123-45-6789” as her SSN. Since this is the second time a card has been purchased with the same buyer SSN within a 365 day period, the card purchase from Oct. 1, 2009 would trigger the threshold and display on the threshold reports. On Mar. 1, 2010, a third buyer attempts to purchase an XYZ GPR card using “123-45-6789” as his SSN. Since this is the third attempted card purchase with the same buyer SSN, the limit is triggered and the card purchase is declined.

In some embodiments, a user configurable “Same government ID per buyer/cardholder for cards ordered within time period” trigger is provided. A limit and threshold trigger can have multiple configurable values for the number of times the same government ID can be used in the buyer or cardholder profile of a prepaid card purchase and the number of days that represents the time period of card purchases (i.e. limit of 3 times in 7 days and limit of 10 times in 30 days). Buyer profiles can include buyers, account holders and gift givers. The limit and threshold can trigger when an aggregate number of times a same government ID is used in the buyer or cardholder profile of a prepaid card purchased during the time period set by the user is greater than the number value set by the user for the program or sub-user. For example, XYZ GPR program has a limit set to 2 card purchases with the same govt ID used in the buyer or cardholder profile within 365 days and a threshold set for 1 time in 365 days. A buyer purchases a card with “123-45-6789” as the SSN on Jul. 1, 2009. On Oct. 1, 2009, another XYZ GPR card is purchased with a cardholder profile using “123-45-6789” as her SSN. Since this is the second time a card has been purchased with the same buyer or cardholder SSN within a 365 day period, the card purchase from Oct. 1, 2009 would trigger the threshold and display on the threshold reports. On Mar. 1, 2010, a third buyer attempts to purchase an XYZ GPR card using “123-45-6789” as his SSN. Since this is the third attempted card purchase with the same buyer SSN, the limit is triggered and the card purchase is declined.

In some embodiments, a user configurable “Same phone per buyer for cards ordered within time period” trigger is provided. A limit and threshold trigger can have multiple configurable values for the number of times the same phone number can be used in the buyer profile of a prepaid card purchase and the number of days that represents the time period of card purchases (i.e. limit of 3 times in 7 days and limit of 10 times in 30 days). Buyer profiles can include buyers, account holders and gift givers. The limit and threshold can trigger when an aggregate number of times a same phone number is used in the buyer profile of a prepaid card purchased during the time period set by the user is greater than the number value set by the user for the program or sub-user. For example, XYZ GPR program has a limit set to 2 card purchases with the same phone number used in the buyer profile within 365 days and a threshold set for 1 time in 365 days. A buyer purchases a card with “789-456-1233” as her phone number on Jul. 1, 2009. On Oct. 1, 2009, another buyer purchases an XYZ GPR card with “789-456-1233” as his phone number. Since this is the second time a card has been purchased with the same phone number within a 365 day period, the card purchase from Oct. 1, 2009 would trigger the threshold and display on the threshold reports. On Mar. 1, 2010, a third person attempts to purchase an XYZ GPR card using “789-456-1233” as his phone number. Since this is the third attempted card purchase with the same phone number, the limit is triggered and the card purchase is declined.

In some embodiments, a user configurable “Same phone per buyer/cardholder for cards ordered within time period” trigger is provided. A limit and threshold trigger can have multiple configurable values for the number of times the same phone number can be used in the buyer or cardholder profile of a prepaid card purchase and the number of days that represents the time period of card purchases (i.e. limit of 3 times in 7 days and limit of 10 times in 30 days). Buyer profiles can include gift giver and account holder profiles. The limit and threshold can trigger when the aggregate number of times the same phone number is used in the buyer or cardholder profile of a prepaid card purchased during the time period set by the user is greater than the number value set by the user for the program or sub-user. For example, XYZ GPR program has a limit set to 2 card purchases with the same phone number used in the buyer or cardholder profile within 365 days and a threshold set for 1 time in 365 days. A buyer purchases a card with “789-456-1233” as her phone number on Jul. 1, 2009. On Oct. 1, 2009, another card is purchased with “789-456-1233” as the cardholder's phone number. Since this is the second time a card has been purchased with the same buyer or cardholder phone number within a 365 day period, the card purchase from Oct. 1, 2009 would trigger the threshold and display on the threshold reports. On Mar. 1, 2010, a third person attempts to purchase an XYZ GPR card using “789-456-1233” as his phone number. Since this is the third attempted card purchase with the same buyer or cardholder phone number, the limit is triggered and the card purchase is declined.

In some embodiments, a user configurable “Max teller cash amt per transaction” is provided. A limit and threshold trigger can have a single configurable trigger value for the maximum dollar amount of a single manual cash disbursement (MCC 6010—Over-the-counter teller cash) from a prepaid account (i.e. limit of $1,000.00 and threshold of $900.00). The limit and threshold can trigger when a manual cash transaction from a prepaid account is greater than the dollar amount value set by the user for the program or sub-user. For example, ABC Bank GPR program has a maximum limit for a single manual cash transaction set at $1,000.00 and a threshold set at $900.00. ABC Bank Payroll cardholder goes into an ABC Bank branch and requests an over-the-counter teller cash transaction for $920.00 on Jul. 1, 2009. Since this is a manual cash transaction for more than the $900.00 threshold, it would trigger the threshold/fraud rule. If the cardholder had requested an over-the-counter cash transaction for $1,020.00, then the transaction would be declined since the transaction was for more than the $1,000.00 limit set. If the user has configured the limit/threshold to automatically open a fraud case then a fraud case would be opened in either scenario. If the user configured the limit/threshold to also automatically block the account, then the account would also be blocked in either scenario.

In some embodiments, a “Max teller cash amt per prepaid acct over time period” is provided. The new Trigger can be available for all card programs with the ability to be activated as part of a program-level Limit Set that can be overridden at the sub-user level (Program Limit Set). The limit and threshold can have multiple configurable values for the maximum dollar amount of multiple manual cash disbursements (MCC 6010—Over-the-counter teller cash) from a prepaid account and the number of days that represents the time period of transactions (i.e. limit of $1,000.00 in 7 days and limit of $5,000.00 in 30 days). The limit and threshold can trigger when the aggregate dollar amount of multiple manual cash transactions from a prepaid account during the time period set by the user is greater than the dollar amount value set by the user for the program or sub-user. For example, ABC Bank GPR program has a maximum limit for a multiple manual cash transactions over a time period set at $1,000.00 in 7 days and a threshold set at $900.00 in 7 days. ABC Bank Payroll cardholder goes into an ABC Bank branch and requests an over-the-counter teller cash transaction for $920.00 on Jul. 1, 2009. Since this is a manual cash transaction for more than the $900.00 in 7 days threshold, it would trigger the threshold/fraud rule. The cardholder returns on Jul. 3, 2009 and requests another over-the-counter cash transaction for $120.00. Since the two transactions are within 7 days and total more than $1,000.00, the limit is triggered and the transaction on Jul. 3, 2009 is declined.

In some embodiments, a user configurable “Max ATM cash/cash back amt per transaction” trigger is provided. The new Trigger can be available for all card programs with the ability to be activated as part of a program-level Limit Set that can be overridden at the sub-user level (Program Limit Set). A limit and threshold trigger can have a single configurable value for the maximum dollar amount of a single automated cash disbursement (MCC 6012—ATM cash and Cash Back portion of a purchase transaction) from a prepaid account (i.e. limit of $1,000.00 and threshold of $900.00). The limit and threshold can trigger when the dollar amount of an automated cash transaction from a prepaid account is greater than the dollar amount value set by the user for the program or sub-user. For example, ABC Bank GPR program has a maximum limit for a single ATM transaction or Cash Back portion of a purchase transaction set at $1,000.00 and a threshold set at $900.00. ABC Bank Payroll cardholder does an ATM transaction for $920.00 on Jul. 1, 2009. Since this is an automated cash transaction for more than the $900.00 threshold, it would trigger the threshold/fraud rule. If the cardholder had attempted an ATM transaction for $1,020.00, then the transaction would be declined since the transaction was for more than the $1,000.00 limit set.

In some embodiments, a user configurable“Max ATM cash/cash back amt per prepaid acct over time period” is provided. A limit and threshold trigger can have multiple configurable values for the maximum dollar amount of an automated cash disbursement (MCC 6012—ATM cash and cash back portion of a purchase transaction) from a prepaid account and the number of days that represents the time period of transactions (i.e. limit of $1,000.00 in 7 days and limit of $5,000.00 in 30 days). The limit and threshold can trigger when an aggregate dollar amount of multiple automated cash transactions from a prepaid account during the time period set by the user is greater than the dollar amount value set by the user for the program or sub-user. For example, ABC Bank GPR program has a maximum limit for multiple ATM transactions and/or the Cash Back portion of purchase transactions over a time period set at $1,000.00 in 7 days and a threshold set at $900.00 in 7 days. ABC Bank Payroll cardholder does an ATM cash transaction for $920.00 on Jul. 1, 2009. Since this is an automated cash transaction for more than the $900.00 in 7 days threshold, it would trigger the threshold/fraud rule. The cardholder goes into a grocery store on Jul. 3, 2009 and requests $120.00 cash back as part of their purchase transaction. Since the two transactions are within 7 days and total more than $1,000.00, the limit is triggered and the transaction on Jul. 3, 2009 is declined. If the user has configured the limit/threshold to automatically open a fraud case then a fraud case would be opened in conjunction with the Jul. 1, 2009 transaction and if the case was still open it would be updated on Jul. 3, 2009. If the first case had been closed, then a new case would be opened on Jul. 3, 2009. If the user configured the limit/threshold to also automatically block the account, then the account would also be blocked in either scenario.

Embodiments of the invention are not limited to the embodiments described herein. For example, although separate functional blocks are shown for an issuer, acquirer, payment processing system, server computer, or remote server, some entities perform some or all of these functions and may be included in embodiments of invention.

Embodiments of the invention are not limited to prepaid cards. For example, the methods and apparatuses disclosed here can be used for credit cards, debit cards, and other types of transaction devices.

It can be understood that the present invention as described above can be implemented in the form of control logic using computer software in a modular or integrated manner. Based on the disclosure and teachings provided herein, a person of ordinary skill in the art can know and appreciate other ways and/or methods to implement the present invention using hardware and a combination of hardware and software.

Any of the software components, user interfaces, or methods described in this application, may be implemented as software code to be executed by a processor using any suitable computer language such as, for example, Java, C++ or Perl using, for example, conventional or object-oriented techniques. The software code may be stored as instructions, or commands on a computer readable medium, such as a random access memory (RAM), a read only memory (ROM), content-addressable memory (CAM), cache, register memory, a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention will become apparent to those skilled in the art upon review of the disclosure. The scope of the invention can, therefore, be determined not with reference to the above description, but instead can be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

It can be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

1. A method for configuring fraud rules comprising:
receiving a threshold trigger selection and a limit trigger selection, the threshold trigger selection and limit trigger selection originating from user input made to an interface for configuring custom fraud rules;
setting, using a processor, at least one threshold trigger in response to the threshold trigger selection made at the interface;
setting, using the processor, at least one limit trigger in response to the limit trigger selection made at the interface; and
applying the at least one threshold trigger and the at least one limit trigger to an action,
wherein triggering the threshold trigger causes a threshold trigger report to be generated and allows the action,
wherein triggering the limit trigger denies the action,
wherein the threshold trigger selection includes a selection made at the interface for a type of entity responsible for triggering the threshold trigger, such that a fraud case associated with the threshold trigger is generated only for the selected types of entities and not for the unselected types of entities.

2. The method of claim 1, wherein a case is created by triggering of the at least one threshold trigger, according to a case creation option made at the interface.

3. The method of claim 1, wherein an account related to the action is blocked from further use by triggering of the at least one threshold trigger, according to a blocking option made at the interface.

4. The method of claim 1, wherein the action is a prepaid card purchase order.

5. The method of claim 1, wherein the action is a management aspect of a prepaid card.

6. The method of claim 1, wherein a case is created by triggering of the at least one limit trigger, according to a case creation option made at the interface.

7. The method of claim 6, wherein an account related to the action is blocked from further use by triggering of the at least one limit trigger, according to a blocking option made at the interface.

8. The method of claim 1, wherein the threshold trigger selection made at the interface comprises changing default settings of the threshold trigger.

9. A system for configuring fraud rules, the system comprising:
a user processor configured to generate an interface for configuring custom fraud rules for a specific buyer of prepaid cards;
an server processor in communication with the user processor, the server processor configured to receive inputs from the interface to configure a fraud rule set, the fraud rule set comprising a threshold trigger and a limit trigger; and
a fraud processor in communication with the server processor, the fraud processor configured to apply the fraud rule set to an action;
wherein triggering the threshold trigger causes the fraud processor to generate a threshold trigger report and allow the action,
wherein triggering the limit trigger causes the fraud processor to deny the action,
wherein the threshold trigger selection includes a selection made at the interface for a type of entity responsible for triggering the threshold trigger, such that a fraud case associated with the threshold trigger is generated only for the selected types of entities and not for the unselected types of entities.

10. A machine readable medium encoded with instructions for causing one or more processors to perform a method comprising:
receiving a threshold trigger selection and a limit trigger selection, the threshold trigger selection and limit trigger selection originating from user input made to an interface for configuring custom fraud rules;
setting at least one threshold trigger in response to the threshold trigger selection made at the interface;
setting at least one limit trigger in response to the limit trigger selection made at the interface; and
applying the at least one threshold trigger and the at least one limit trigger to an action,
wherein triggering the threshold trigger causes a threshold trigger report to be generated and allows the action,
wherein triggering the limit trigger denies the action,
wherein the threshold trigger selection includes a selection made at the interface for a type of entity responsible for triggering the threshold trigger, such that a fraud case associated with the threshold trigger is generated only for the selected types of entities and not for the unselected types of entities.

11. A method for managing a fraud rule set, the method comprising:
using a processor to electronically generate an interface for customizing a fraud rule set, the fraud rule set being applicable to an action and comprising threshold and limit triggers;
using the processor to process a user command from the interface to change at least one of the threshold and limit triggers; and
using the processor to change the at least one of the threshold and limit triggers in response to the command,
wherein triggering the threshold trigger causes a threshold trigger report to be generated and allows the action,
wherein triggering the limit trigger denies the action,
wherein the threshold trigger selection includes a selection made at the interface for a type of entity responsible for triggering the threshold trigger, such that a fraud case associated with the threshold trigger is generated only for the selected types of entities and not for the unselected types of entities.

12. The method of claim 11, wherein at least one of the threshold and limit triggers comprises a location and a prepaid card order amount.

13. The method of claim 11, wherein at least one of the threshold and limit triggers comprises a time period and a prepaid card order amount.

14. The method of claim 11, wherein an account related to the action is blocked from further use by triggering at least one of the threshold and limit triggers.

15. The method of claim 11, wherein a report is always generated upon meeting at least one of the threshold and limit triggers.

16. The method of claim 11, wherein at least one of the threshold and limit triggers comprises a triggering velocity.

17. The method of claim 16, wherein a result of meeting the at least one threshold and limit trigger is overridden for certain velocities exceeding the triggering velocity.

18. The method of claim 11, wherein a case is created upon meeting at least one of the threshold and limit triggers.

19. The method of claim 11, wherein the transaction is always denied upon triggering the limit.

20. A machine readable medium encoded with instructions for causing one or more processors to perform a method comprising:
using a processor to electronically generate an interface for customizing a fraud rule set, the fraud rule set being applicable to an action and comprising threshold and limit triggers;
using the processor to process a user command from the interface to change at least one of the threshold and limit triggers; and
using the processor to change the at least one of the threshold and limit triggers in response to the command,
wherein triggering the threshold trigger causes a threshold trigger report to be generated and allows the action,
wherein triggering the limit trigger denies the action,
wherein the threshold trigger selection includes a selection made at the interface for a type of entity responsible for triggering the threshold trigger, such that a fraud case associated with the threshold trigger is generated only for the selected types of entities and not for the unselected types of entities.

21. A system for managing a fraud rule set, the system comprising:
a user processor configured to generate a user interface for customizing settings for a fraud rule set, the fraud rule set being applicable to particular entity;
a rules processor configured for:
receiving a first command from the user processor to access the settings for the fraud rule set;
presenting, in response to the first command, current settings for the fraud rule set on the interface;
receiving a second command from the user processor to change at least one of the settings of the fraud rule set; and
changing the at least one setting of the settings of the fraud rule set in response to the second command; and
a fraud processor in communication with the rules processor, the fraud processor being configured to apply the changed fraud rule set to an action of the entity,
wherein the threshold trigger selection includes a selection made at the interface for a type of entity responsible for triggering the threshold trigger, such that a fraud case associated with the threshold trigger is generated only for the selected types of entities and not for the unselected types of entities.

22. The method of claim 1, wherein the selection for the type of entity is made according to predetermined categories selectable on the interface.

23. The method of claim 22, wherein the predetermined categories include cardholder, card buyer, and gift card giver.

24. The method of claim 11, wherein the selection for the type of entity is made according to predetermined categories selectable on the interface.

25. The method of claim 24, wherein the predetermined catagories include cardholder, card buyer, and gift card giver.
